(19) United States
(12) Patent Application Publication
(10) Pub. No.: US 2018/0290325 A1
(43) Pub. Date: Oct. 11, 2018

(54) Fluid Container Assembly

(71) Applicant: Manuel Andrade, Randolph, MA (US)

(72) Inventor: Manuel Andrade, Randolph, MA (US)

(21) Appl. No.: 15/481,163

(22) Filed: Apr. 6, 2017

(51) Int. Cl. B26D 3/30; B65D 35/10; B65D 25/40; B26D 1/06

(52) U.S. Cl. CPC B26D 3/30; B26D 1/06; B65D 25/40; B65D 35/10

(57) ABSTRACT

A fluid container assembly includes a container that may contain a fluid. The container is structured to be selectively bisected to facilitate an entirety of the fluid to be removed from the container. A cutter is movably coupled to the container and the cutter is selectively manipulated. Moreover, the cutter bisects the container when the cutter is manipulated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to container devices and more particularly pertains to a new container device that is selectively bisected to remove an entirety of the contents of the container.

### BRIEF SUMMARY OF THE INVENTION

An embodiment of the disclosure meets the needs presented above by generally comprising a container that may contain a fluid. The container is structured to be selectively bisected to facilitate an entirety of the fluid to be removed from the container. A cutter is movably coupled to the container and the cutter is selectively manipulated. Moreover, the cutter bisects the container when the cutter is manipulated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a fluid container assembly according to an embodiment of the disclosure.

FIG. 2 is a back view of an embodiment of the disclosure.

FIG. 3 is a back perspective view of an embodiment of the disclosure.

FIG. 4 is a right side view of an embodiment of the disclosure.

FIG. 5 is a perspective view of an alternative embodiment of the disclosure.

### DETAILED DESCRIPTION OF THE INVENTION

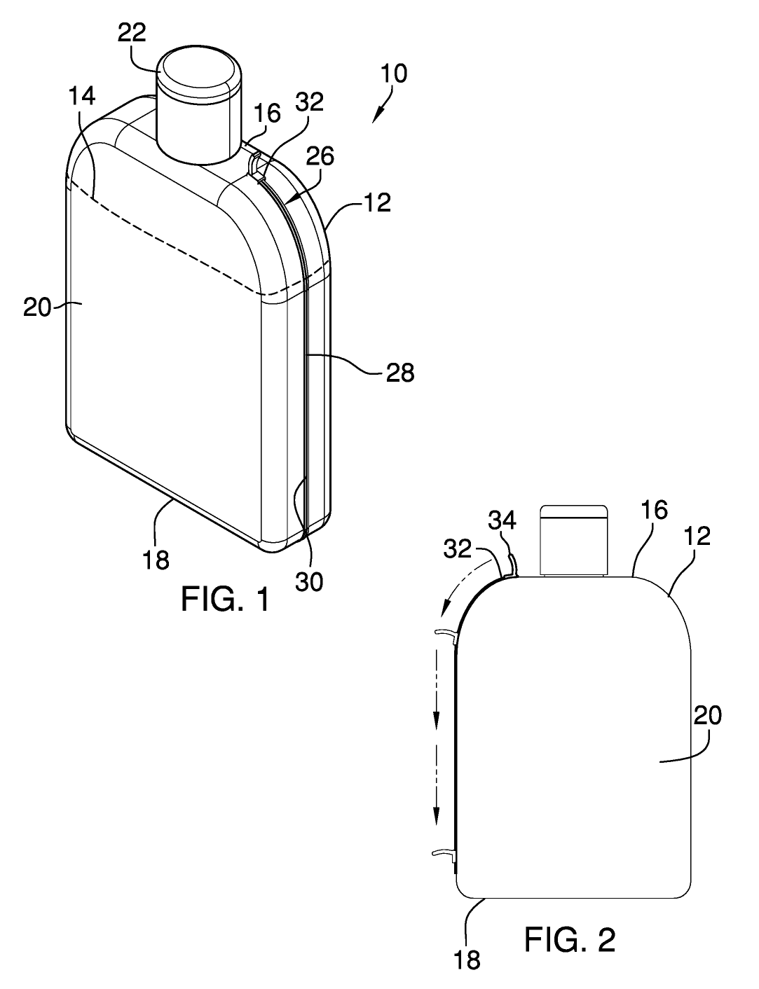

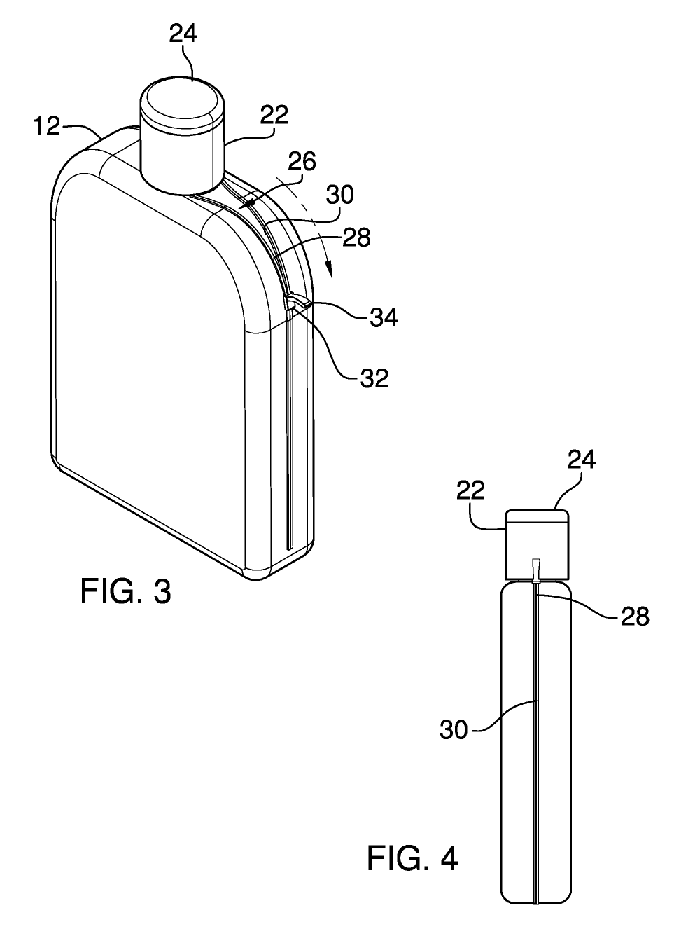

With reference now to the drawings, and in particular to FIGS. 1 through 5 thereof, a new container device embodying the principles and concepts of an embodiment of the disclosure and generally designated by the reference numeral 10 will be described.

As best illustrated in FIGS. 1 through 5, the fluid container assembly 10 generally comprises a container 12 that contains a fluid 14. The fluid 14 may be toothpaste, shampoo, conditioner or any other type of fluid 14 employed for personal hygiene. Additionally, the container 12 may be a bottle, a tube or any other container 12 commonly employed to selectively release a fluid 14. The container 12 is structured to be selectively bisected to access an interior of the container 12. In this way the container 12 facilitates an entirety of the fluid 14 to be removed from the container 12.

The container 12 has a first end 16, a second end 18 and an outer wall 20 extending therebetween. A spout 22 is coupled to the first end 16 and the spout 22 is in fluid 14 communication with the interior of the container 12. Moreover, the spout 22 has a distal end 24 with respect to the first end 16 and the distal end 24 is open. The distal end 24 of the spout 22 selectively releases the fluid 14 from the container 12 in the convention of shampoo bottles, toothpaste tubes or other fluid 14 containers. A cap may be removably coupled to the spout 22 to close the spout 22.

The outer wall 20 has a cut 26 extending into an interior of the container 12. The cut 26 has a first edge 28 and a second edge 30 and the cut 26 extends substantially between the first end 16 and the second end 18. The first edge 28 is hermitically sealed to the second edge 30. In this way the cut 26 forms a fluid 14 impermeable seal to inhibit the fluid 14 from escaping outwardly through the cut 26.

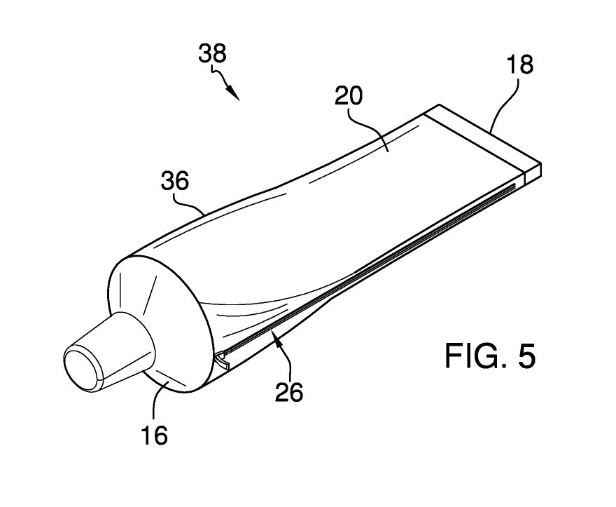

A cutter 32 is movably coupled to the container 12 and the cutter 32 is selectively manipulated. The cutter 32 is slidably coupled to the outer wall 20 and the cutter 32 is positioned to be aligned with the cut 26. Additionally, the cutter 32 extends through the outer wall 20 of the container 12. The cutter 32 splits the first edge 28 from the second edge 30 when the cutter 32 is manipulated to access the interior of the container 12. Additionally, a tab 34 extends away the cutter 32 and the tab 34 is gripped to manipulate the cutter 32. The cutter 32 may be structured in the convention of a zipper or the like. A toothpaste tube 36 is shown in an alternative embodiment 38 as shown in FIG. 5.

In use, the container 12 is selectively squeezed to release the fluid 14 from the spout 22. The cutter 32 is manipulated to split the first edge 28 from the second edge 30 when the fluid 14 becomes depleted to the point that the fluid 14 can no longer be released from the spout 22. In this way the container 12 is bisected to facilitate the last remaining amount of fluid 14 to be removed from the container 12. The container 12 is discarded when the container 12 is bisected and the last remaining amount of the fluid 14 is removed from the container 12. Moreover, the container 12 reduces waste with respect to inaccessible amounts of the fluid 14 that would otherwise remain in the container 12 when the container 12 is discarded.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A fluid container assembly being selectively bisected wherein said assembly is configured to facilitate an entirety of a fluid in said assembly to be removed, said assembly comprising:
a container being configured to contain a fluid, said container being structured to be selectively bisected wherein said container is configured to facilitate an entirety of the fluid to be removed from said container, said container having an outer wall; and
a cutter being movably coupled to said container wherein said cutter is configured to be manipulated, said cutter bisecting said container when said cutter is manipulated, said cutter being slidably coupled to said outer wall, said cutter having a tab extending away from said outer wall, said tab being elongated and arcuate along a longitudinal axis of said tab extending away from said outer wall wherein said tab is configured to be gripped.

2. The assembly according to claim 1, wherein said container has a first end, a second end and said outer wall extending therebetween, said outer wall having a cut extending into an interior of said container, said cutter being positioned to be aligned with said cut, said cut having a first edge and a second edge, said cut extending substantially between said first end and said second end.

3. The assembly according to claim 2, wherein said first edge is hermitically sealed to said second edge such that said cut forms a fluid impermeable seal wherein said cut is configured to inhibit the fluid from escaping outwardly therefrom.

4. The assembly according to claim 2, further comprising said cutter splitting said first edge from said second edge when said cutter is manipulated to access said interior of said container.

5. A fluid container assembly being selectively bisected wherein said assembly is configured to facilitate an entirety of a fluid in said assembly to be removed, said assembly comprising:
a container being configured to contain a fluid, said container being structured to be selectively bisected wherein said container is configured to facilitate an entirety of the fluid to be removed from said container, said container having a first end, a second end and an outer wall extending therebetween, said outer wall having a cut extending into an interior of said container, said cut having a first edge and a second edge, said cut extending substantially between said first end and said second end, said first edge being hermitically sealed to said second edge such that said cut forms a fluid impermeable seal wherein said cut is configured to inhibit the fluid from escaping outwardly therefrom; and
a cutter being movably coupled to said container wherein said cutter is configured to be manipulated, said cutter bisecting said container when said cutter is manipulated, said cutter being slidably coupled to said outer wall, said cutter being positioned to be aligned with said cut, said cutter splitting said first edge from said second edge when said cutter is manipulated to access said interior of said container, said cutter having a tab extending away from said outer wall, said tab being elongated and arcuate along a longitudinal axis of said tab extending away from said outer wall wherein said tab is configured to be gripped.
